(19) United States
(12) Patent Application Publication
(10) Pub. No.: US 2010/0088768 A1
(43) Pub. Date: Apr. 8, 2010

(54) INDUSTRIAL PROCESS VISUALIZATION APPLICATION HAVING AN OPERATING SYSTEM LOCALE-BASED REGIONALLY LIMITED LICENSE

(75) Inventors: Robert B. Hunter, Orange, CA (US); Keith N. Jones, Rancho Santa Margarita, CA (US); Rashesh Mody, San Clemente, CA (US); Gary W. Nelson, Foothill Ranch, CA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Invensys Systems, Inc., Foxboro, MA (US)

(21) Appl. No.: 12/245,335

(22) Filed: Oct. 3, 2008

(51) Int. Cl. H04L 9/32

(52) U.S. Cl. 726/26

(57) ABSTRACT

A computer system and method are described for enforcing a locale-based license restriction by a process visualization application program. A locale-based license configuration is read from a license file associated with the process visualization application program. An operating system application program interface is called to identify a current locale of the operating system. The current locale affects a language utilized to present text via a graphical user interface display. Thereafter, a locale specified by the locale-based license configuration is compared to the current locale of the operating system. Thereafter, a licensing result is generated representing success or failure based upon whether the locale specified by the locale-based license configuration matches the current locale of the operating system. The aforementioned steps are carried out in a computer system including a computer-readable medium having computer-executable instructions for carrying out the above-described steps.

### FIELD OF THE INVENTION

This invention generally relates to the area of process visualization application programs and computer systems upon which such programs execute. More particularly, the present invention concerns industrial process visualization application programs executed on personal-computer systems running locale-specific operating systems wherein a particular region is unalterably specified by an operating system executing on a computer system hosting the aforementioned visualization application.

### BACKGROUND OF THE INVENTION

Computer systems are utilized for the design, configuration, and/or management of manufacturing/industrial processes and managing information generated by such processes. Such computer systems and/or associated process visualization application programs are sold in a variety of regions throughout the world. These regions typically exhibit highly diverse economic states. Consequently, it is desirable, from a process visualization application licensor's point of view, to license their systems and/or associated process visualization application software at differing prices to match the unique economic state of various regions.

Once software has been licensed to a licensee at a reduced rate to meet a particular region's economic state, the licensor has a strong interest to ensure the software is not thereafter relocated to a region where economic conditions support a substantially higher licensing fee. Failure to effectively enforce a region-based license on process visualization application programs can potentially lead to cannibalization of licensing revenues in premium markets where such licenses command a substantially higher price. Relying on words of a license agreement alone to enforce a region-limited software license is difficult since subsequent enforcement of the agreement is likely to be too costly.

### SUMMARY OF THE INVENTION

In view of the above need to effectively enforce region-limited licenses for process visualization application programs, a method and computer system executing a process visualization application program are described herein.

More particularly, a method for enforcing a locale-based license restriction by a process visualization application program is disclosed herein. The method includes initially reading a locale-based license configuration from a license file associated with the process visualization application program. Thereafter, a further step is performed of calling an operating system application program interface to identify a current locale of the operating system. The current locale affects a language utilized to present text via a graphical user interface display. Thereafter, a locale specified by the locale-based license configuration is compared to the current locale of the operating system. Thereafter, a licensing result is generated representing success or failure based upon whether the locale specified by the locale-based license configuration matches the current locale of the operating system.

The invention is also embodied in a computer system and computer-readable medium including computer-executable instructions for carrying out the above-described steps.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic drawing identifying particular components of a computer system embodying a locale-based licensing arrangement for process visualization application software;

FIG. 2 summarizes contents of an exemplary license file that is used by an exemplary process visualization application program to determine license terms for execution of the program on a particular computer system including a callable function for providing a “locale” with which the computer system (including an executing operating system and graphical display) is associated; and

FIG. 3 is a flowchart summarizing steps performed in association with a locale-based licensing arrangement carried out on a personal computer system executing an operating system capable of providing a locale to a process visualization application including a locale-restricted license.

### DETAILED DESCRIPTION OF THE DRAWINGS

In the illustrative embodiment of the present invention disclosed herein, a process visualization application program executing on a personal computer calls an operating system application program interface (API) to determine a locale associated with the personal computer. By way of example, the API provides a language designation of the operating system. More particularly, the personal computer runs the MICROSOFT WINDOWS® operating system, and a licensing procedure associated with the process visualization application program calls a “GetUserDefaultLCID( )” method to provide the language currently used by the operating system hosting the executing process visualization application program. In this particular example, the “locale” is represented by a current language being used by the operating system.

In a particular example, software is licensed with a “Chinese” designation. Executable instructions associated with a locale-based licensing feature incorporated into the process visualization application program, when executed, access the language designation for the computer's operating system. If the operating system is currently using Chinese as its language, then the process visualization application program will continue to operate in a license success (e.g., fully operable) mode according to the license. Otherwise, if the operating system is not using Chinese, then a failure condition is noted, and the process visualization application operates according to a license failure (e.g., “demonstration”) mode. In the illustrative example, the user can overcome a previous license failure by specifying the Chinese regional setting for the operating system and re-invoking the locale-based license test.

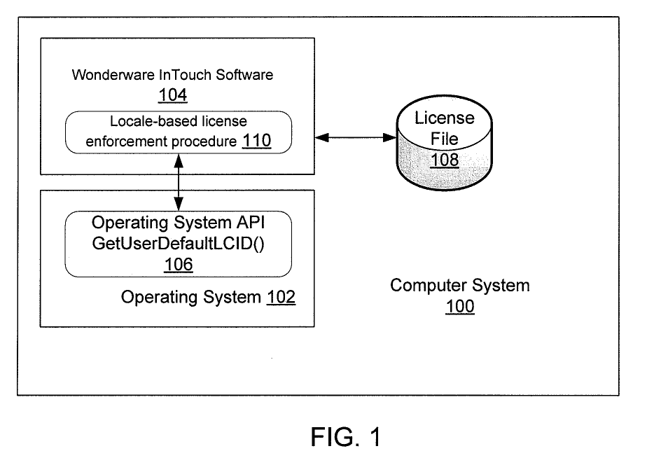

Turning initially to FIG. 1, a schematic drawing identifies particular components of a computer system embodying a locale-based licensing arrangement for process visualization application software in accordance with an exemplary embodiment. In the illustrative example, a personal computer 100 comprises suitable hardware, firmware, and software for running an operating system 102 and a process visualization application program 104 (e.g., INTOUCH®). In an exemplary embodiment, the personal computer 100 is any suitable computer system hardware including one or more processors, memory, physical I/O interfaces (network, USB, keyboard, mouse, etc.), and a graphical display (e.g., LCD monitor) device facilitating user interaction with programs executing on the personal computer 100. Various types of suitable personal computer systems will be known to those skilled in the art.

The operating system 102 is, by way of example, any of a variety of MICROSOFT WINDOWS® versions. In accordance with an exemplary embodiment, the operating system 102 includes an application program interface (API) 106. The API 106 in turn includes a callable function/method/procedure that, when invoked, furnishes a locale for the operating system. The “locale”, as used herein, is provided by the operating system in potentially many different forms in accordance with alternative exemplary embodiments. In a particular exemplary embodiment the locale is provided by the MICROSOFT WINDOWS® GetUserDefaultLCID( ) API component that is part of a multi-language user interface (MUI) of the operating system 102.

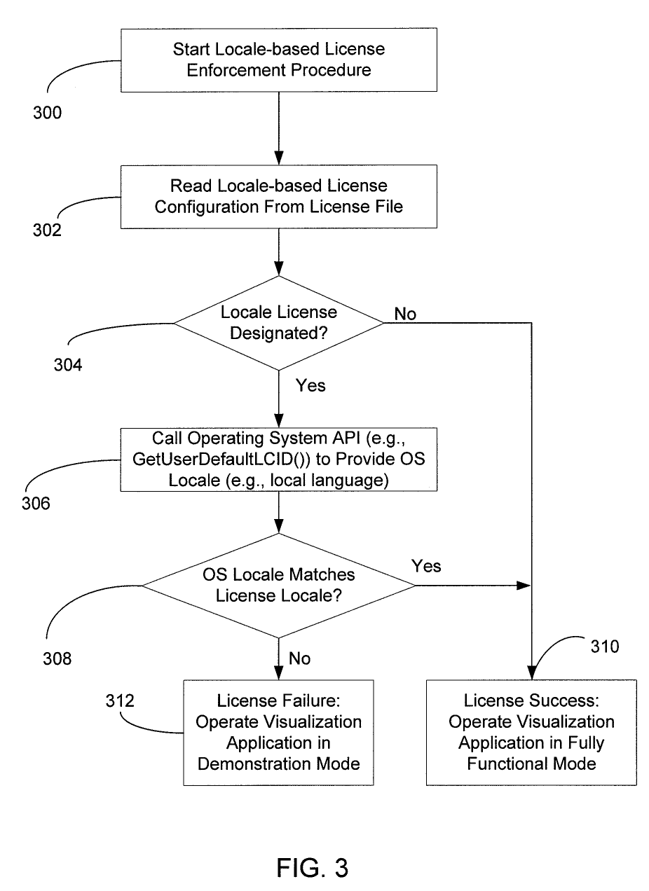

In an exemplary embodiment, the GetUserDefaultLCID( ) API component is called by a locale-based license enforcement procedure 110 of the visualization application program 104 running on the computer 100. In an exemplary embodiment, the visualization application program 104 includes multiple execution events that invoked the license enforcement procedure 110. For example, in an embodiment wherein the visualization application program 104 is INTOUCH, the license enforcement procedure 110 is invoked, and the steps summarized in FIG. 3 (described herein below) are executed, in response to a user opening WindowMaker and WindowViewer processes within INTOUCH.

The GetUserDefaultLCID( ) API component, when called by the license enforcement procedure 110, provides a local language for the operating system 102 (e.g., Chinese). The local language can be changed by users via the “Regional Settings” option in the Control Panel of the MICROSOFT WINDOWS® OS. Thus, while the term “locale” may suggest a particular geographic region, as used herein it is intended to refer to information provided by the operating system 102 indicative of a particular geographic region—including a language specified via Regional Settings of the OS. Therefore, if the personal computer 100 is running the operating system 102 in the Chinese language mode of operation, then the “locale” will be Chinese regardless of the actual geographic location of the personal computer 100. Similarly, if a personal computer running in China specifies the English (United States) setting, then the “locale” will be the United States.

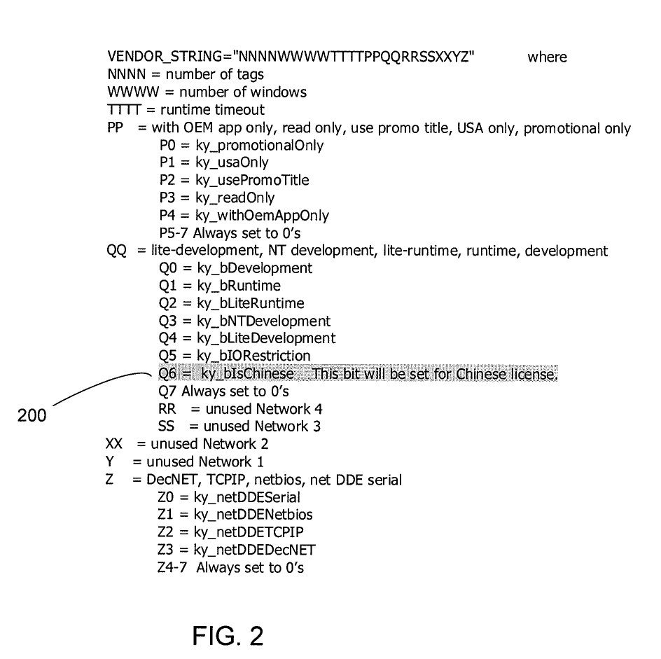

In the illustrative example depicted in FIG. 1, the locale restriction on the operation of the visualization application program 104 is specified via a license file 108. In the exemplary embodiment, the license file 108 comprises a bit string defining the terms upon which the visualization application program 104 is licensed. An exemplary licensing schema is summarized in FIG. 2 (described herein below). In the exemplary embodiment, the locale-based license restriction is specified in the form of a locale-license bit specifying a locale restriction for the associated visualization application program 104. When operating, the visualization application program 104 accesses the locale license bit in the license file 108 and compares the locale restriction specified in the license file 108 to the current locale of the operating system 102 to ensure compliance with a locale-based license restriction (e.g., Chinese operation only). The illustrative embodiment utilizes a single bit in a bit string to identify a locale restriction. Alternatively, a string of bits can be used within the license file 108 to indicate one or more specific locales (e.g., OS language settings) for which the application program 104 is licensed for use.

Turning to FIG. 2 an exemplary license file schema is provided. The fields of the exemplary license file schema define permissions and restrictions associated with the process visualization application program 104. In the illustrative license file schema, a single locale-license configuration bit 200, identified as “Q6”, is set in the license file 108 to indicate that the associated visualization application program 104 is licensed to operate only when the locale (e.g., the local language) of the operating system 102 is set to Chinese. In alternative embodiments, additional bits are allocated to specify other locale tests to be performed by the license enforcement procedure 110 in accordance with a locale-based license restriction.

Thus, the exemplary embodiment utilizes an external file (108) to define a locale-based license restriction for the application program 104. In alternative embodiments, the locale-based license restrictions are specified within the application program 104, rather than rely upon an externally referenced license definition such as the license file 108.

Turning to FIG. 3, a flowchart summarizes a set of steps associated with the locale-based license enforcement procedure 110 carried out by the process visualization application program 104 in response to a local-based license enforcement event (e.g., startup of an WindowMaker or WindowViewer process in the INTOUCH visualization application program). During step 300, the license enforcement procedure 110 is started in response to a license enforcement event associated with the visualization application 104.

At step 302 the license enforcement procedure 110 reads the locale-license configuration bit 200 in the license file 108. If, at step 304, the locale-license configuration bit 200 is not set, then the license file is not specifying any locale-based license restriction for the visualization application program 104, and control passes to step 310 (assuming all other license terms are met). If at step 304 the locale-license configuration bit 200 is set, then the application program 104 has a locale-based restriction, and control passes to step 306. In the illustrative example, a Chinese locale restriction is the only specified restriction. In other embodiments multiple bits are defined within the license file schema to support multiple designated locales (e.g., one bit for each supported locale).

At step 306 the “locale” of the operating system in which the application program 104 product is running is determined. In an exemplary embodiment, the license enforcement procedure 110 calls the GetUserDefaultLCID( ) function of the WINDOWS API to determine the currently configured local language of the operating system. In alternative embodiments, the operating system API provides alternative locale identification data such as, for example, a regional OS build code indicative of an intended region in which the operating system is intended to be used. The important aspect of the locale identification provided by the operating system 102 is that it corresponds to a language used by the operating system 102 to present a graphical user interface.

Next, during step 308, if the license enforcement procedure 110 determines that the locale (local language determined during step 306) of the operating system matches the locale restriction specified by the locale-license configuration bit 200 (e.g., both specify Chinese locale), then the application 104 is running in an OS environment prescribed by the license file 108 and control passes to step 310 wherein the license enforcement procedure 110 returns a “license success” response that indicates the licensed application program 104 can operate in its fully functional licensed mode.

On the other hand, during step 308, if the locale of the operating system does not match the locale restriction (Chinese) specified by the license file 108, then a license failure has occurred and control passes to step 312. A variety of license failure modes of operation are contemplated in accordance with various alternative embodiments—including simply shutting down the application. In a particular exemplary embodiment, at step 312 the application program 104 responds to a locale-based license failure event by operating in a reduced capacity—also referred to as a demonstration mode. Other optional behaviors associated with a license failure include providing a reason for failure (in the local language determined during step 306) and describing a way to overcome the failure (e.g., change the local language of the operating system 102).

Finally, it is noted that the aforementioned license restrictions are intended to augment already existing license terms (e.g., concurrent users/windows, tags, etc.) represented in the license file 108.

It will be appreciated by those skilled in the art that a new and useful method and a PC system for carrying out a locale-based process visualization application program 20 licensing arrangement have been described herein. In view of the many possible environments to which the principles of this invention may be applied, it should be recognized that the embodiments described herein with reference to computer-executable instructions stored upon a physical computer readable medium are meant to be illustrative and should not be taken as limiting the scope of invention. Those skilled in the art to which the present invention applies will appreciate that the illustrated embodiments can be modified in arrangement and detail without departing from the spirit of the invention. Therefore, the invention as described herein contemplates all such embodiments as may come within the scope of the following claims and equivalents thereof.

What is claimed is:

1. A method for enforcing a locale-based license restriction by a process visualization application program, the method comprising the steps of:
reading a locale-based license configuration from a license file associated with the process visualization application program;
calling an operating system application program interface to identify a current locale of an operating system, the current locale affecting a language utilized to present text via a graphical user interface display;
comparing a locale specified by the locale-based license configuration to the current locale of the operating system; and
generating a licensing result representing success or failure based upon whether the locale specified by the locale-based license configuration matches the current locale of the operating system.

2. The method of claim 1 further comprising the step of:
running the process visualization application program in a fully functional mode in response to a license success result rendered during the generating step.

3. The method of claim 1 further comprising the step of:
running the process visualization application program in a demonstration mode in response to a license failure result rendered during the generating step.

4. The method of claim 1 wherein the calling step comprises calling an operating system application program interface function that provides a current language mode utilized by the operating system.

5. The method of claim 4 wherein the application program interface function identifies a user-configurable current language of the operating system.

6. The method of claim 1 wherein the locale of interest is Chinese.

7. The method of claim 1 wherein the locale-based license configuration is specified by a locale configuration bit contained within a bit string defining license parameters.

8. The method of claim 1 wherein the license file is maintained separately from the process visualization application program.

9. A computer readable-medium including a process visualization application program comprising computer-executable instructions for enforcing a locale-based license restriction method comprising the steps of:
reading a locale-based license configuration from a license file associated with the process visualization application program;
calling an operating system application program interface to identify a current locale of an operating system, the current locale affecting a language utilized to present text via a graphical user interface display;
comparing a locale specified by the locale-based license configuration to the current locale of the operating system; and
generating a licensing result representing success or failure based upon whether the locale specified by the locale-based license configuration matches the current locale of the operating system.

10. The computer-readable medium of claim 9 further comprising the step of:
running the process visualization application program in a fully functional mode in response to a license success result rendered during the generating step.

11. The computer-readable medium of claim 9 wherein the calling step comprises calling an operating system application program interface function that provides a current language mode utilized by the operating system.

12. The computer-readable medium of claim 11 wherein the application program interface function identifies a user-configurable current language of the operating system.

13. The computer-readable medium of claim 9 wherein the locale of interest is Chinese.

14. The computer-readable medium of claim 9 wherein the locale-based license configuration is specified by a locale configuration bit contained within a bit string defining license parameters.

15. A computer system including:
a processor;
a graphical user interface display; and
a computer readable-medium including:
an operating system including an application program interface exposing a function for identifying a current locale of the operating system, the current locale affecting a language utilized to present text via the graphical user interface display, and
a process visualization application program comprising computer-executable instructions for enforcing a locale-based license restriction method comprising the steps of:
reading a locale-based license configuration from a license file associated with the process visualization application program;
calling an operating system application program interface to identify a current locale of the operating system, the current locale affecting a language utilized to present text via the graphical user interface display;
comparing a locale specified by the locale-based license configuration to the current locale of the operating system; and
generating a licensing result representing success or failure based upon whether the locale specified by the locale-based license configuration matches the current locale of the operating system.

16. The computer system of claim 15 further comprising the step of:
running the process visualization application program in a fully functional mode in response to a license success result rendered during the generating step.

17. The computer system of claim 15 wherein the calling step comprises calling an operating system application program interface function that provides a current language mode utilized by the operating system.

18. The computer system of claim 17 wherein the application program interface function identifies a user-configurable current language of the operating system.

19. The computer system of claim 15 wherein the locale of interest is Chinese.

20. The computer system of claim 15 wherein the locale-based license configuration is specified by a locale configuration bit contained within a bit string defining license parameters.
